(19) United States
(12) Patent Application Publication
(10) Pub. No.: US 2026/0276951 A1
(43) Pub. Date: Sep. 17, 2026

(54) LAMINATED OPTICAL SYSTEM AND ENDOSCOPE

(71) Applicant: OLYMPUS MEDICAL SYSTEMS CORP., Tokyo (JP)

(72) Inventor: Takahiro AMANAI, Hachioji-shi (JP)

(73) Assignee: OLYMPUS MEDICAL SYSTEMS CORP., Tokyo (JP)

(21) Appl. No.: 19/354,087

(22) Filed: Oct. 9, 2025

(30) Foreign Application Priority Data
Mar. 11, 2025 (JP) 2025-038374

(51) Int. Cl. G02B 13/00; G02B 7/02; G02B 9/34; G02B 23/24

(52) U.S. Cl. CPC G02B 13/004; G02B 7/025; G02B 7/028; G02B 9/34; G02B 13/006; G02B 23/243

(57) ABSTRACT

Provided is a laminated optical system that has a wide angle of view and is environmentally resistant by suppressing changes in performance due to temperature changes.

The laminated optical system includes four lens portions, and in each lens portion, a parallel flat plate and a plano-concave lens or a plano-convex lens having a partially curved surface are adhered to each other. In each lens portion, the linear expansion coefficient of the plano-concave lens or the plano-convex lens is greater than the linear expansion coefficient of the parallel flat plate.

### BACKGROUND OF THE INVENTION

### Field of the Invention

The present invention relates to a laminated optical system and an endoscope. Priority is claimed on Japanese Patent Application No. 2025-038374, filed Mar. 11, 2025, the content of which is incorporated herein by reference.

### Description of Related Art

A laminated optical system is used in a small optical system used in an imaging device equipped with an optical system, such as an endoscope. As a laminated optical system, for example, an optical system including a plurality of hybrid lenses is known. A hybrid lens includes a lens portion obtained by adhering a surface of a plate-shaped member made of a resin on an image side or object side, on which a lens is formed, to a flat surface of a parallel flat plate made of glass on an object side or image side.

For example, U.S. Pat. No. 9,798,115 discloses an optical system including the hybrid lens described above. The optical system disclosed in U.S. Pat. No. 9,798,115 includes a first lens portion, a second lens portion, and a third lens portion which are disposed in that order from an object side. The first lens portion is formed by adhering a parallel substrate made of glass and a plano-concave lens made of a resin to each other and has a negative refractive power. The second lens portion is formed by adhering a plano-convex lens made of a resin and a parallel flat plate made of glass to each other and has a positive refractive power. The third lens portion is formed by adhering a parallel flat plate made of glass and a plano-convex lens made of a resin to each other and has a positive refractive power. On an optical axis, the first lens portion and the second lens portion are disposed to be spaced apart from each other, and an aperture stop is disposed between the second lens portion and the third lens portion. The parallel flat plate of the second lens portion, the aperture stop, and the parallel flat plate of the third lens portion are adhered to each other.

### SUMMARY OF THE INVENTION

A laminated optical system of an embodiment of the present invention includes a first lens portion having a negative refractive power, a second lens portion having a negative refractive power, a third lens portion having a positive refractive power, and a fourth lens portion having a positive refractive power which are disposed in that order from an object side to an image side. The first lens portion has a first parallel flat plate and a first plano-concave lens having a first concave surface of which a concave surface faces the image side and a first flat surface on an outer peripheral side of the first concave surface which are disposed in that order from the object side to the image side. A flat surface on an image side of the first parallel flat plate and a flat surface on an object side of the first plano-concave lens are adhered to each other. The second lens portion has a second parallel flat plate and a second plano-concave lens having a second concave surface of which a concave surface faces the image side and a second flat surface on an outer peripheral side of the second concave surface which are disposed in that order from the object side to the image side. The first flat surface of the first plano-concave lens and a flat surface on the object side of the second parallel flat plate are adhered to each other. A flat surface on the image side of the second parallel flat plate and the second flat surface of the second plano-concave lens are adhered to each other. The third lens portion has a first plano-convex lens having a first convex surface of which a convex surface faces the object side and a third flat surface on an outer peripheral side of the first convex surface and a third parallel flat plate which are disposed in that order from the object side to the image side. The second concave surface of the second plano-concave lens and the first convex surface of the first plano-convex lens are disposed with an interval therebetween. The second flat surface of the second plano-concave lens and the third flat surface of the first plano-convex lens are adhered to each other. A flat surface on the image side of the first plano-convex lens and a flat surface on the object side of the third parallel flat plate are adhered to each other. The fourth lens portion has a second plano-convex lens having a second convex surface of which a convex surface faces the object side and a fourth flat surface on an outer peripheral side of the second convex surface and a fourth parallel flat plate which are disposed in that order from the object side to the image side. A flat surface on the image side of the third parallel flat plate and the second convex surface of the second plano-convex lens are disposed with an interval therebetween. The flat surface on the image side of the third parallel flat plate and the fourth flat surface of the second plano-convex lens are adhered to each other, and a flat surface on the image side of the second plano-convex lens and a flat surface on the object side of the fourth parallel flat plate are adhered to each other. A linear expansion coefficient of the first plano-concave lens is greater than a linear expansion coefficient of the first parallel flat plate, a linear expansion coefficient of the second plano-concave lens is greater than a linear expansion coefficient of the second parallel flat plate, a linear expansion coefficient of the first plano-convex lens is greater than a linear expansion coefficient of the third parallel flat plate, and a linear expansion coefficient of the second plano-convex lens is greater than a linear expansion coefficient of the fourth parallel flat plate.

### BRIEF DESCRIPTION OF THE DRAWINGS

FIG. 1 is a schematic view of a laminated optical system according to an embodiment of the present invention.

FIG. 2 is a schematic view of an endoscope including the laminated optical system shown in FIG. 1.

FIG. 3 is an aberration diagram of a laminated optical system of a first example.

FIG. 4 is an aberration diagram of a laminated optical system of a second example.

FIG. 5 is an aberration diagram of a laminated optical system of a third example.

FIG. 6 is an aberration diagram of a laminated optical system of a fourth example.

### DETAILED DESCRIPTION OF THE INVENTION

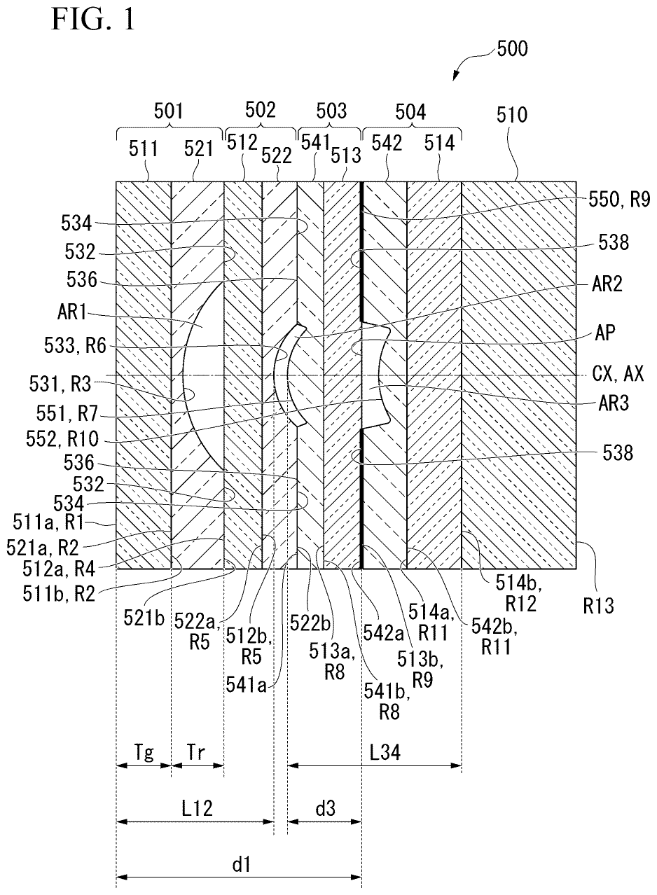

Hereinafter, a laminated optical system and an endoscope according to an embodiment will be described with reference to the drawings. First, the laminated optical system of the present embodiment will be described. FIG. 1 is a view showing a configuration of a laminated optical system 500 according to the present embodiment.

As shown in FIG. 1, the laminated optical system 500 includes a first lens portion 501 having a negative refractive power, a second lens portion 502 having a negative refractive power, a third lens portion 503 having a positive refractive power, and a fourth lens portion 504 having a positive refractive power which are disposed in that order from an object side to an image side and further includes an optical filter 510 disposed on the image side of the fourth lens portion 504.

The first lens portion 501 has a first parallel flat plate 511 and a first plano-concave lens 521 which are disposed in that order from the object side to the image side. The first parallel flat plate 511 has a flat surface 511a on the object side and a flat surface 511b on the image side. The first plano-concave lens 521 has a flat surface 521a on the object side and a first partially curved surface 521b on the image side. The flat surfaces 511a, 511b, and 521a are perpendicular to a central axis CX of the laminated optical system 500. The first partially curved surface 521b has a first concave surface 531 of which a concave surface faces the image side and a first flat surface 532 that is provided to be radially continuous with the first concave surface 531 with respect to the central axis CX and is disposed on an outer peripheral side of the first concave surface 531.

The flat surface 511b on the image side of the first parallel flat plate 511 and the flat surface 521a on the object side of the first plano-concave lens 521 are adhered to each other by integral formation during manufacturing as will be described below or with an adhesive for flat surface bonding (not shown). The adhesive for flat surface bonding is made of, for example, an energy curable resin material such as an ultraviolet curable resin material.

The second lens portion 502 has a second parallel flat plate 512 and a second plano-concave lens 522 which are disposed in that order from the object side to the image side. The second parallel flat plate 512 has a flat surface 512a on the object side and a flat surface 512b on the image side. The second plano-concave lens 522 has a flat surface 522a on the object side and a second partially curved surface 522b on the image side. The flat surfaces 512a, 512b, and 522a are perpendicular to the central axis CX of the laminated optical system 500. The second partially curved surface 522b has a second concave surface 533 of which a concave surface faces the image side and a second flat surface 534 that is provided to be radially continuous with the second concave surface 533 with respect to the central axis CX and is disposed on an outer peripheral side of the second concave surface 533.

The flat surface 512a on the object side of the second parallel flat plate 512 of the second lens portion 502 and the first flat surface 532 of the first partially curved surface 521b on the image side of the first plano-concave lens 521 of the first lens portion 501 are adhered to each other with an adhesive for flat surface bonding. An area AR1 of air having a shape similar to that of a plano-convex lens of which a convex surface faces the object side is present between the flat surface 512a on the object side of the second parallel flat plate 512 of the second lens portion 502 and the first concave surface 531 of the first partially curved surface 521b on the image side of the first plano-concave lens 521 of the first lens portion 501.

In the second lens portion 502, the flat surface 512b on the image side of the second parallel flat plate 512 and the flat surface 522a on the object side of the second plano-concave lens 522 are adhered to each other by integral formation during manufacturing or with an adhesive for flat surface bonding.

The third lens portion 503 has a first plano-convex lens 541 and a third parallel flat plate 513 which are disposed in that order from the object side to the image side. The first plano-convex lens 541 has a third partially curved surface 541a on the object side and a flat surface 541b on the image side. The third parallel flat plate 513 has a flat surface 513a on the object side and a flat surface 513b on the image side. The flat surfaces 541b, 513a, and 513b are perpendicular to the central axis CX of the laminated optical system 500. The third partially curved surface 541a has a first convex surface 551 of which a concave surface faces the object side and a third flat surface 536 that is provided to be radially continuous with the first convex surface 551 with respect to the central axis CX and is disposed on an outer peripheral side of the first convex surface 551.

The third flat surface 536 of the third partially curved surface 541a on the object side of the first plano-convex lens 541 of the third lens portion 503 and the second flat surface 534 of the second partially curved surface 522b on the image side of the second plano-concave lens 522 of the second lens portion 502 are adhered to each other with an adhesive for flat surface bonding. In the third lens portion 503, an outer peripheral end of the first convex surface 551 of the third partially curved surface 541a on the object side of the first plano-convex lens 541 is located at a position closer to the image side than the third flat surface 536. The apex of the first convex surface 551 on the central axis CX is located to be closer to the object side than the third flat surface 536. An area AR2 of air having a shape similar to that of a positive meniscus lens of which a convex surface faces the object side is present between the first convex surface 551 and the second concave surface 533 of the second partially curved surface 522b on the image side of the second plano-concave lens 522 of the second lens portion 502. Each of the diameter of the second concave surface 533 and the diameter of the first convex surface 551 is smaller than the diameter of the first concave surface 531 of the first partially curved surface 521b of the first plano-concave lens 521 of the first lens portion 501.

In the third lens portion 503, the flat surface 541b on the image side of the first plano-convex lens 541 and the flat surface 513a on the object side of the third parallel flat plate 513 are adhered to each other by integral formation during manufacturing or with an adhesive for flat surface bonding.

The fourth lens portion 504 has a second plano-convex lens 542 and a fourth parallel flat plate 514 which are disposed in that order from the object side to the image side. The second plano-convex lens 542 has a fourth partially curved surface 542a on the object side and a flat surface 542b on the image side. The fourth parallel flat plate 514 has a flat surface 514a on the object side and a flat surface 514b on the image side. The flat surfaces 542b, 514a, and 514b are perpendicular to the central axis CX of the laminated optical system 500. The fourth partially curved surface 542a has a second convex surface 552 of which a concave surface faces the object side and a fourth flat surface 538 that is provided to be radially continuous with the second convex surface 552 with respect to the central axis CX and is disposed on an outer peripheral side of the second convex surface 552.

The fourth flat surface 538 of the fourth partially curved surface 542a on the object side of the second plano-convex lens 542 of the fourth lens portion 504 and the flat surface 513b on the image side of the third parallel flat plate 513 of the third lens portion 503 are adhered to each other with an adhesive for flat surface bonding. In the fourth lens portion 504, an outer peripheral end of the second convex surface 552 of the fourth partially curved surface 542a on the object side of the second plano-convex lens 542 is located at a position closer to the image side than the fourth flat surface 538. The apex of the second convex surface 552 on the central axis CX is located to be closer to the image side than the fourth flat surface 538. An area AR3 of air having a shape similar to that of a plano-concave lens of which a concave surface faces the image side is present between the second convex surface 552 and the flat surface 513b on the image side of the third parallel flat plate 513 of the third lens portion 503. The diameter of the second convex surface 552 is equal to each of the diameter of the second concave surface 533 of the second partially curved surface 522b of the second plano-concave lens 522 of the second lens portion 502 and the diameter of the first convex surface 551 of the third partially curved surface 541a of the first plano-convex lens 541 of the third lens portion 503 and is smaller than the diameter of the first concave surface 531 of the first partially curved surface 521b of the first plano-concave lens 521 of the first lens portion 501.

In the fourth lens portion 504, the flat surface 542b on the image side of the second plano-convex lens 542 and the flat surface 514a on the object side of the fourth parallel flat plate 514 are adhered to each other by integral formation during manufacturing or with an adhesive for flat surface bonding.

The dimensions of the four lens portions from the first lens portion 501 to the fourth lens portion 504 in planes perpendicular to the central axis CX and the optical axis AX are equal to each other.

The optical filter 510 is disposed on the image side of the fourth lens portion 504. The flat surface on the object side of the optical filter 510 and the flat surface on the image side of the fourth parallel flat plate 514 of the fourth lens portion 504 are adhered to each other by integral formation during manufacturing or with an adhesive for flat surface bonding. The dimensions of the optical filter 510 in a plane perpendicular to the central axis CX and optical axis AX are preferably equal to the dimensions of the four lens portions in planes perpendicular to the central axis CX and optical axis AX but are not particularly limited thereto. The optical filter 510 is, for example, a cover glass of an imaging element such as a complementary metal oxide semiconductor (CMOS). In other words, the laminated optical system 500 may be adhered to a cover glass of an imaging element that acts as the optical filter 510.

In the first lens portion 501, the linear expansion coefficient of a medium of the first plano-concave lens 521 is greater than the linear expansion coefficient of a medium of the first parallel flat plate 511. In the second lens portion 502, the linear expansion coefficient of a medium of the second plano-concave lens 522 is greater than the linear expansion coefficient of a medium of the second parallel flat plate 512. In the third lens portion 503, the linear expansion coefficient of a medium of the first plano-convex lens 541 is greater than the linear expansion coefficient of a medium of the third parallel flat plate 513. In the fourth lens portion 504, the linear expansion coefficient of a medium of the second plano-convex lens 542 is greater than the linear expansion coefficient of a medium of the fourth parallel flat plate 514. The linear expansion coefficient of the medium of each of the parallel flat plates described above is, for example, about 8.0×10⁻⁶ [/° C.]. The linear expansion coefficient of each of the plano-concave lenses or plano-convex lenses described above is, for example, about 6.0×10⁻⁶ [/° C.].

As described above, the laminated optical system 500 of the present embodiment is formed of four lens portions, from the first lens portion 501 to the fourth lens portion 504, and each lens portion is formed of a cemented body of the parallel flat plate and the plano-concave lens or plano-convex lens having the partially curved surface, and the lens portions are formed by adhering the flat surfaces on the outer peripheral side of an effective diameter, which is obtained due to each concave surface or convex surface, to each other. The laminated optical system 500 of the present embodiment is manufactured by a manufacturing process and a processing process that are advantageous for mass productivity and miniaturization. In the laminated optical system 500 of the present embodiment, the four lens portions, from the first lens portion 501 to the fourth lens portion 504, are integrated, and thus there is no need for a plurality of support members that individually support each lens portion and the parallel flat plate, the plano-concave lens, and the plano-convex lens of each lens portion, making it easy to reduce size and cost. An optical filter, a stop, a spacer, an optical coating layers, or the like may be interposed between the lens portions of the laminated optical system 500 of the present embodiment and between the parallel flat plate and the plano-concave lens or plano-convex lens having a partially curved surface.

In the laminated optical system 500 of the present embodiment, the first lens portion 501 having a negative refractive power, the second lens portion 502 having a negative refractive power, the third lens portion 503 having a positive refractive power, and the fourth lens portion 504 having a positive refractive power are disposed in that order from the object side to the image side, and two lens portions having a negative refractive power are disposed on the object side over the total length on the central axis CX and the optical axis AX of the light incident on the laminated optical system 500, thereby realizing a retrofocus type optical system. The laminated optical system 500 of the present embodiment is advantageous in terms of a wide angle of view and a reduction in aberration due to the division of a negative refractive power.

In each lens portion from the first lens portion 501 to the fourth lens portion 504, the linear expansion coefficient of the parallel flat plate is different from the linear expansion coefficient of the plano-concave lens or plano-convex lens having a partially curved surface, and thus slight changes in shape of the lens portions occur during a heating process or a cooling process during manufacturing. When the changes in shape of all of the lens portions occur on the same side, either the object side or the image side, the influence of changes in the overall shape of the laminated optical system and the degradation of optical performance due to the changes in shape will be significant. In the laminated optical system 500 of the present embodiment, the first lens portion 501 and the second lens portion 502 have concave surfaces that are concave toward the object side, in the first lens portion 501 and the second lens portion 502, changes in shape that is concave toward the object side are likely to occur, the third lens portion 503 and the fourth lens portion 504 have convex surfaces that are initially concave toward the object side and then protrude, and in the third lens portion 503 and the fourth lens portion 504, changes in shape that is concave toward the image side are likely to occur. According to the laminated optical system 500 of the present embodiment, changes in shape of the four lens portions from the first lens portion 501 to the fourth lens portion 504 tend to be cancelled out on the object side and the image side, and thus changes in the overall shape of the optical system and reduction in optical performance due to changes in temperature are suppressed, and environmental resistance is achieved.

According to the laminated optical system 500 of the present embodiment, since the laminated optical system 500 has the configuration described above, it is possible to provide a laminated optical system that is compact and low-cost, has a wide angle of view, and has environmental resistance to changes and reductions in optical performance due to temperature changes.

It is preferable that the laminated optical system 500 of the present embodiment further have the following configuration or satisfy the following conditions.

The first parallel flat plate 511 of the first lens portion 501 is made of glass, and a medium of the first parallel flat plate 511 is glass. The first plano-concave lens 521 is made of a resin, and a medium of the first plano-concave lens 521 is a resin. The second parallel flat plate 512 of the second lens portion 502 is made of glass, and a medium of the second parallel flat plate 512 is glass. The second plano-concave lens 522 is made of a resin, and a medium of the second plano-concave lens 522 is a resin. The first plano-convex lens 541 of the third lens portion 503 is made of a resin, and a medium of the first plano-convex lens 541 is a resin. The third parallel flat plate 513 is made of glass, and a medium of the third parallel flat plate 513 is glass. The second plano-convex lens 542 of the fourth lens portion 504 is made of a resin, and a medium of the second plano-convex lens 542 is a resin. The fourth parallel flat plate 514 is made of glass, and a medium of the fourth parallel flat plate 514 is glass.

In the laminated optical system 500 of the present embodiment, when manufacturing each of the lens portions from the first lens portion 501 to the fourth lens portion 504, the parallel flat plate made of glass is used as a substrate, and the resin plano-concave lens or plano-convex lens having a partially curved surface on the flat surface of the parallel flat plate is formed integrally with the parallel flat plate, thereby making it possible to miniaturize and mass-produce the entire optical system. For example, the lens portions of the laminated optical system 500 can be easily manufactured using standard manufacturing processes by applying a resin, which is the medium for the plano-concave lens or the plano-convex lens, to the flat surface of a base material of the parallel flat plate made of glass to form a resin layer, pressing the resin layer in a mold capable of forming a plurality of convex or concave surfaces, and cutting the parallel flat plate to dimensions corresponding to each lens portion. In the laminated optical system 500 of the present embodiment, since the parallel flat plate made of glass is used as the substrate, changes in refractive index due to external factors such as heat during manufacturing are suppressed, thereby stabilizing optical performance.

In the laminated optical system 500 of the present embodiment, when the parallel flat plate of each lens portion is made of glass and the plano-concave lens or plano-convex lens is made of a resin, changes in shape are likely to occur due to the difference in linear expansion coefficients between the glass and the resin. However, as described above, the changes in shape of the four lens portions are cancelled out on the object side and the image side, and thus the optical performance is stable and ensured.

The first plano-concave lens 521 of the first lens portion 501, the second plano-concave lens 522 of the second lens portion 502, the first plano-convex lens 541 of the third lens portion 503, and the second plano-convex lens 542 of the fourth lens portion 504 are made of, for example, an energy curable resin material such as an ultraviolet curable resin material. The resin material described above is different from the resin material of the adhesive for flat surface bonding.

According to the laminated optical system 500 of the present embodiment, the plano-concave lens or plano-convex lens of each lens portion is made of an energy curable resin material, thereby preventing plastic deformation of the plano-concave lens or convex-plano lens due to heat and suppressing deterioration of the optical performance.

The distance from the flat surface 511a on the object side of the first parallel flat plate 511 of the first lens portion 501 to the second concave surface 533 of the second plano-concave lens 522 of the second lens portion 502 on the central axis CX and the optical axis AX is defined as L12. The distance from the first convex surface 551 of the first plano-convex lens 541 of the third lens portion 503 to the flat surface 514b on the image side of the fourth parallel flat plate 514 of the fourth lens portion 504 on the central axis CX and the optical axis AX is defined as L34. In the laminated optical system 500 of the present embodiment, the following expression (1) is established.

$$0.8 < L 12 / L 34 < 1. \qquad ( 1 )$$

In the laminated optical system 500 of the present embodiment, the above-described arrangement of the four lens portions from the first lens portion 501 to the fourth lens portion 504 reduces the influence of changes in shape of each lens portion during the heating process and cooling process during manufacturing. In the laminated optical system 500 of the present embodiment, good optical performance is obtained because Expression (1) is established. When L12/L34 is smaller than or equal to the lower limit value of Expression (1), the changes in shape of the third lens portion 503 and the fourth lens portion 504, that is, the influence of the warp concave toward the image side, is excessively large, and thus the suppression effect against deformation of the shape of the first lens portion 501 and the second lens portion 502 is weak, and changes in field curvature of the laminated optical system 500 and deterioration of the optical performance are likely to occur. When L12/L34 is greater than or equal to the upper limit value of Expression (1), the changes in shape of the first lens portion 501 and the second lens portion 502, that is, the influence of the warp concave toward the object side, is excessively large, and thus the suppression effect against deformation of the shape of the third lens portion 503 and the fourth lens portion 504 is weak, and changes in spherical aberration of the laminated optical system 500 and deterioration of the optical performance are likely to occur.

When the thickness of the first parallel flat plate 511 of the first lens portion 501 on the optical axis is defined as Tg and the thickness from the flat surface 521a on the object side to the first flat surface 532 of the first partially curved surface 521b on the image side of the first plano-concave lens 521 of the first lens portion 501 is defined as Tr, the following expression (2) is established.

$$0.16 < Tr / Tg < 1.6 \qquad ( 2 )$$

In the laminated optical system 500 of the present embodiment, the thickness of the first parallel flat plate 511 of the first lens portion 501 satisfies Expression (2), and thus deformation of the first plano-concave lens 521 due to thermal factors can be further suppressed. When Tr/Tg is smaller than or equal to the lower limit value of Expression (2), the thickness of the outer peripheral portion of the first plano-concave lens 521 relative to the first concave surface 531 is not sufficiently secured, making it difficult to achieve a wide angle of view or reduce off-axis aberration in the laminated optical system 500. When Tr/Tg is greater than or equal to the upper limit value of Expression (2), the thickness of the outer peripheral portion of the first plano-concave lens 521 relative to the first concave surface 531 becomes excessively large, and the changes in shape due to thermal changes during processing of the first lens portion 501 is likely to be excessively large. When Tr/Tg is greater than or equal to the upper limit value of Expression (2), the optical performance is likely to deteriorate due to deformation, and cracks due to changes in shape of the first lens portion 501 or detachment of the first plano-concave lens 521 from the first parallel flat plate 511 may occur.

When the focal distance of the first lens portion 501 is defined as f1 and the focal distance of the second lens portion 502 is defined as f2, the following expression (3) is established.

$$0.7 < f 1 / f 2 < 3.5 \qquad ( 3 )$$

In the laminated optical system 500 of the present embodiment, since Expression (3) is established, the overall size of the optical system can be reduced, and the optical performance can be improved while achieving a wide angle of view. When f1/f2 is smaller than or equal to the lower limit value of Expression (3), the negative refractive power of the first lens portion 501 acts excessively on the second lens portion 502, leading to an increase in size of the first lens portion 501 and making it easy for chromatic aberration of magnification to occur in the first lens portion 501. When f1/f2 is greater than or equal to the upper limit value of Expression (3), the negative refractive power of the second lens portion 502 acts excessively on the first lens portion 501, leading to an increase in size of the second lens portion 502 and making it easy for chromatic aberration of magnification to occur in the second lens portion 502.

The laminated optical system 500 of the present embodiment further includes an aperture stop 550 (not shown) in which an aperture AP is formed. The aperture stop 550 is disposed between the flat surface 513b on the image side of the third parallel flat plate 513 of the third lens portion 503 and the fourth flat surface 538 of the second plano-convex lens 542 of the fourth lens portion 504. The aperture stop 550 is made, for example, by forming a light-shielding layer of black paint or the like having light-shielding properties in the area on the flat surface 513b on the image side of the third parallel flat plate 513 of the third lens portion 503, which is closer to the outer peripheral side than the area of the aperture AP. When the distance from the flat surface 511a on the object side of the first parallel flat plate 511 of the first lens portion 501 to the aperture AP on the central axis CX and the optical axis AX is defined as d1 and the distance from the first convex surface 551 of the first plano-convex lens 541 of the third lens portion 503 to the aperture AP on the central axis CX and the optical axis AX is defined as d3, the following expression (4) is established.

$$3. < d 1 / d 3 < 3.8 \qquad ( 4 )$$

In the laminated optical system 500 of the present embodiment, Expression (4) is established, which enables a wide angle of view and compactness to be achieved at the same time, and the chromatic aberration of magnification occurring in the first lens portion 501 and the second lens portion 502 can be effectively corrected by the third lens portion 503. When d1/d3 is smaller than or equal to the lower limit value of Expression (4), the distance from the third partially curved surface 541a on the object side of the third lens portion 503 to the aperture AP of the aperture stop 550 becomes excessively small, the effect of correcting the chromatic aberration of magnification by the third lens portion 503 becomes weak, and a decrease in image quality is likely to occur in the area on the outer peripheral side with respect to the optical axis AX. When d1/d3 is greater than or equal to the upper limit value of Expression (4), the distance from the third partially curved surface 541a of the third lens portion 503 to the aperture AP of the aperture stop 550 becomes excessively large, and the laminated optical system 500 becomes large.

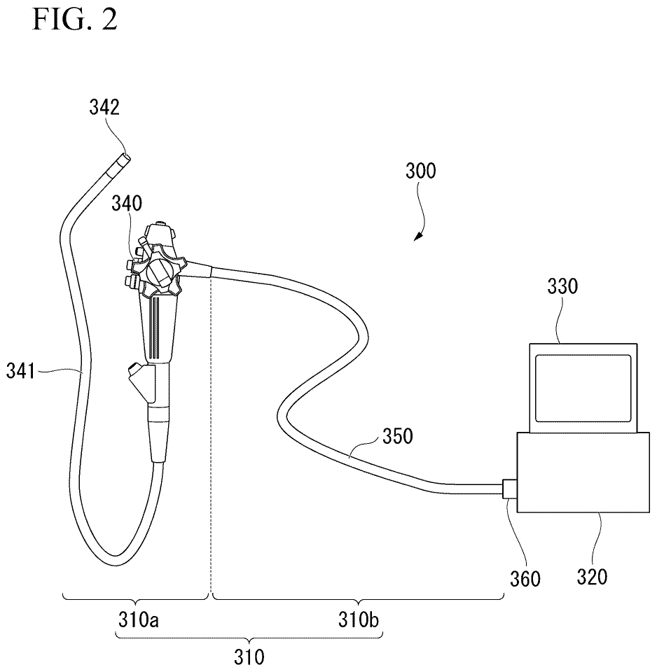

Next, an endoscope including the laminated optical system of the present embodiment will be described. FIG. 2 is a schematic view of an endoscope system (an endoscope) 300 as an endoscope according to the present embodiment.

As shown in FIG. 2, the endoscope system 300 is an observation system that uses an electronic endoscope. The endoscope system 300 includes an electronic endoscope 310 and an image processing device 320. The electronic endoscope 310 has a scope portion 310a and a connection cord portion 310b. A display unit 330 is connected to the image processing device 320. The scope portion 310a is roughly divided into an operation portion 340 and an insertion portion 341. The insertion portion 341 is formed long and can be inserted into a body cavity of a patient. The insertion portion 341 is made of a flexible member.

The observer can perform various operations using an angle knob or the like provided on the operation portion 340. The connection cord portion 310b is connected to the operation portion 340. The connection cord portion 310b has a universal cord 350. The universal cord 350 is connected to the image processing device 320 via a connector 360. The universal cord 350 is used for transmitting and receiving various signals. The various signals include a power supply voltage signal, a CCD drive signal, an image signal, and the like. These signals are transmitted from a power supply device and a video processor to the scope portion 310a and then transmitted from the scope portion 310a to the video processor.

The video processor in the image processing device 320 can be connected to peripheral devices such as a storage device and a video printer (not shown). The video processor performs signal processing on the image signal from the scope portion 310a. An endoscopic image is displayed on a display screen of the display unit 330 on the basis of the image signal.

An optical system is disposed at a tip end portion 342 of the insertion portion 341. The laminated optical system 500 of the present embodiment is housed and installed in the optical system.

According to the endoscope system 300 of the present embodiment, the tip end portion 342 of the insertion portion 341 is provided with the laminated optical system 500 of the present embodiment, which has a wide angle of view, has suppressed performance changes due to temperature changes, and is environmentally resistant, making it possible to perform high-precision observations over a wider range of areas to be observed than with the endoscope systems of the related art.

### EXAMPLES

Hereinafter, examples of the laminated optical system 500 according to the above-described embodiment will be described. Each of the following examples shows a specific example of the present invention, and the present invention is not limited to each of the examples.

### Example 1

The unit of a numerical value denoting the length in the following numerical values is millimeters (mm).

### Surface Data

TABLE 1

| Surface number (R) | r | d | nd | νd |
|---|---|---|---|---|
| 1 | ∞ | 0.30 | 1.52330 | 54.52 |
| 2 | ∞ | 0.07 | 1.52558 | 54.02 |
| 3* | 1.000 | 0.23 | | |
| 4 | ∞ | 0.21 | 1.52330 | 54.52 |
| 5 | ∞ | 0.07 | 1.52558 | 54.02 |
| 6* | 0.290 | 0.10 | | |
| 7* | 0.292 | 0.21 | 1.59950 | 29.43 |
| 8 | ∞ | 0.21 | 1.52330 | 54.52 |
| 9 (Stop) | ∞ | 0.09 | | |
| 10* | 0.464 | 0.15 | 1.52558 | 54.02 |
| 11 | ∞ | 0.30 | 1.52330 | 54.52 |
| 12 | ∞ | 0.67 | 1.47140 | 64.97 |
| 13 | ∞ | 0.00 | | |

*Aspheric data

TABLE 2
Third surface (R3)

| | | |
|---|---|---|
| k = −0.413 | | |
| A4 = −2.99485 × 10⁻² | A6 = 1.97380 × 10¹ | A8 = −5.51104 × 10¹ |

Sixth surface (R6)

| | | |
|---|---|---|
| k = −2.024 | | |
| A4 = 8.17298 × 10⁰ | A6 = −5.84014 × 10² | A8 = 1.24127 × 10⁴ |
| A10 = −7.30206 × 10⁴ | | |

Seventh surface (R7)

| | | |
|---|---|---|
| k = −1.269 | | |
| A4 = 6.96181 × 10⁰ | A6 = −4.96927 × 10² | A8 = 1.21794 × 10⁴ |
| A10 = −8.92970 × 10⁴ | | |

Tenth surface (R10)

| | | |
|---|---|---|
| k = −1.329 | | |
| A4 = −4.16127 × 10⁰ | A6 = −5.08435 × 10¹ | A8 = 2.25816 × 10³ |
| A10 = −1.68378 × 10⁴ | | |

*Basic data

TABLE 3

| | |
|---|---|
| Focal distance | 0.526 |
| F number | 3.899 |
| Total length | 2.607 |
| Image height | 0.459 |
| Total angle of view (°) | 128.323 |
| DT_0.5d | −57.418 |
| fb (in air) | 0.95 |
| Total length (in air) | 2.59 |

*Element value

TABLE 4

| | |
|---|---|
| L12 | 0.88 |
| L34 | 0.96 |
| Tg | 0.30 |
| Tr | 0.30 |
| f1 | −1.89 |
| f2 | −0.55 |
| d1 | 1.40 |
| d3 | 0.42 |

*Conditional expression

TABLE 5

| | | |
|---|---|---|
| Conditional Expression (1) | L12/L34 | 0.92 |
| Conditional Expression (2) | Tr/Tg | 1.00 |
| Conditional Expression (3) | f1/f2 | 3.44 |
| Conditional Expression (4) | d1/d3 | 3.35 |

In the surface data of each example in the present specification, r represents the radius of curvature of each of the lens surfaces, d represents the interval between the lens surfaces, nd represents the refractive index of the d line of each of the lenses, νd represents the Abbe number of each of the lenses, and * represents an aspheric surface. The stop is an aperture stop.

The aspheric shape of each example in the present specification is expressed by the following equation, where z is the optical axis direction, y is the direction perpendicular to the optical axis, k is the conic coefficient, and A4, A6, A8, A10, . . . are aspheric coefficients.

$$z = ( {y}^{2} / r ) / [ 1 + {\{ 1 - ( 1 + k ) {( y / r )}^{2} \}}^{1 / 2} ] + A 4 {y}^{4} + A 6 {y}^{6} + A 8 {y}^{8} + A 10 {y}^{10} …$$

DT_0.5d in the basic data of each example in the present specification is the distortion at the maximum image height. The unit of DT_0.5d is %. fb (in air) is the back focus length in a case in which it is assumed that the medium from the exit surface to the image surface of the laminated optical system is air. The exit surface of the laminated optical system 500 in the examples of the present specification is the flat surface 514b on the image side of the fourth parallel flat plate 514 of the fourth lens portion 504. The total length (in air) is the distance from the entrance surface to the image surface of the laminated optical system in a case in which it is assumed that the medium from the exit surface to the image surface of the laminated optical system is air, and the entrance surface of the laminated optical system 500 in the examples of the present specification is the flat surface 511a on the object side of the first parallel flat plate 511 of the first lens portion 501.

The symbols of these specification values and data are also commonly used in the numerical data of each of the examples from Example 2 onwards.

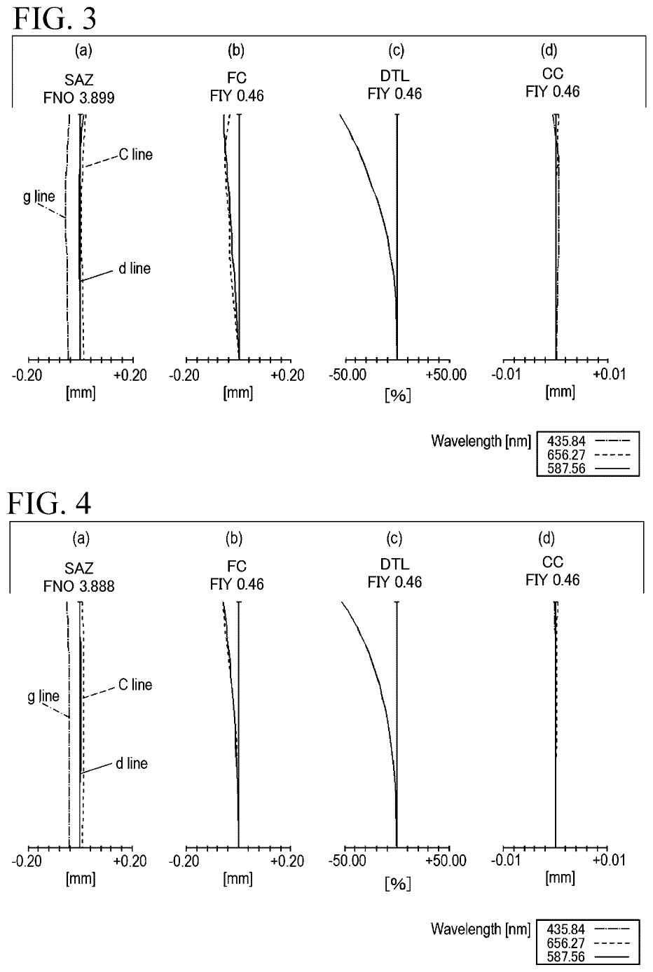

FIG. 3 is an aberration diagram of the laminated optical system of Example 1. FIG. 3A shows spherical aberration (SA). FIG. 3B shows astigmatism (AS). FIG. 3C shows distortion (DT). FIG. 3D shows chromatic aberration of magnification (CC).

### Example 2

### Surface Data

TABLE 6

| Surface | | | | |
|---|---|---|---|---|
| number (R) | r | d | nd | νd |
| 1 | ∞ | 0.30 | 1.52330 | 54.52 |
| 2 | ∞ | 0.07 | 1.52558 | 54.02 |
| 3* | 0.700 | 0.25 | | |
| 4 | ∞ | 0.21 | 1.52330 | 54.52 |
| 5 | ∞ | 0.07 | 1.52558 | 54.02 |
| 6* | 0.337 | 0.07 | | |
| 7* | 0.285 | 0.16 | 1.59950 | 29.43 |
| 8 | ∞ | 0.21 | 1.52330 | 54.52 |
| 9 (Stop) | ∞ | 0.11 | | |
| 10* | 0.441 | 0.15 | 1.52558 | 54.02 |
| 11 | ∞ | 0.27 | 1.52330 | 54.52 |
| 12 | ∞ | 0.62 | 1.47140 | 64.97 |
| 13 | ∞ | 0.00 | | |

*Aspheric data

TABLE 7
Third surface (R3)

| | | |
|---|---|---|
| k = −0.744 | | |
| A4 = −4.60708 × 10−1 | A6 = 5.65481 × 10⁰ | A8 = −6.72817 × 10⁰ |

Sixth surface (R6)

| | | |
|---|---|---|
| k = −2.723 | | |
| A4 = 1.39332 × 10¹ | A6 = −1.52398 × 10² | A8 = −2.58722 × 10² |

Seventh surface (R7)

| | | |
|---|---|---|
| k = −2.761 | | |
| A4 = 1.45940 × 10¹ | A6 = −9.03674 × 10¹ | A8 = −2.18159 × 10³ |

Tenth surface (R10)

| | | |
|---|---|---|
| k = −2.603 | | |
| A4 = −3.72321 × 10⁰ | A6 = 4.92202 × 10¹ | A8 = −1.59510 × 10² |

*Basic data

TABLE 8

| | |
|---|---|
| Focal distance | 0.486 |
| F number | 3.888 |
| Total length | 2.494 |
| Image height | 0.459 |
| Total angle of view (°) | 129.426 |
| DT_0.5d | −55.122 |
| fb (in air) | 0.87 |
| Total length (in air) | 2.47 |

*Element value

TABLE 9

| | |
|---|---|
| L12 | 0.90 |
| L34 | 0.91 |
| Tg | 0.30 |
| Tr | 0.32 |
| f1 | −1.33 |
| f2 | −0.64 |
| d1 | 1.34 |
| d3 | 0.37 |

*Conditional expression

TABLE 10

| | | |
|---|---|---|
| Conditional Expression (1) | L12/L34 | 0.99 |
| Conditional Expression (2) | Tr/Tg | 1.05 |
| Conditional Expression (3) | f1/f2 | 2.08 |
| Conditional Expression (4) | d1/d3 | 3.61 |

FIG. 4 is an aberration diagram of a laminated optical system of Example 2. FIG. 4A shows spherical aberration (SA). FIG. 4B shows astigmatism (AS). FIG. 4C shows distortion (DT). FIG. 4D shows chromatic aberration of magnification (CC).

### Example 3

### Surface Data

TABLE 11

| Surface | | | | |
|---|---|---|---|---|
| number (R) | r | d | nd | νd |
| 1 | ∞ | 0.50 | 1.52330 | 54.52 |
| 2 | ∞ | 0.07 | 1.52558 | 54.02 |
| 3* | 0.360 | 0.25 | | |
| 4 | ∞ | 0.21 | 1.52330 | 54.52 |
| 5 | ∞ | 0.07 | 1.52558 | 54.02 |
| 6* | 0.450 | 0.10 | | |
| 7* | 0.376 | 0.23 | 1.59950 | 29.43 |
| 8 | ∞ | 0.21 | 1.52330 | 54.52 |
| 9 (Stop) | ∞ | 0.08 | | |
| 10* | 0.436 | 0.15 | 1.52558 | 54.02 |
| 11 | ∞ | 0.50 | 1.52330 | 54.52 |
| 12 | ∞ | 0.75 | 1.47140 | 64.97 |
| 13 | ∞ | 0.00 | | |

*Aspheric data

TABLE 12
Third surface (R3)

| | |
|---|---|
| k = −0.293 | |
| A4 = −3.70481 × 10⁰ | A6 = 5.49438 × 10⁰ |

Sixth surface (R6)

| | |
|---|---|
| k = −1.058 | |
| A4 = 1.65366 × 10¹ | A6 = −5.41595 × 10⁰ |

Seventh surface (R7)

| | |
|---|---|
| k = −0.626 | |
| A4 = 7.28914 × 10⁰ | A6 = 3.60446 × 10⁻¹ |

Tenth surface (R10)

| | |
|---|---|
| k = −3.152 | |
| A4 = −2.31306 × 10⁰ | A6 = 4.60837 × 10¹ |

*Basic data

TABLE 13

| | |
|---|---|
| Focal distance | 0.442 |
| F number | 3.785 |
| Total length | 3.118 |
| Image height | 0.459 |
| Total angle of view (°) | 133.191 |
| DT_0.5d | −54.087 |
| fb (in air) | 1.24 |
| Total length (in air) | 3.11 |

*Element value

TABLE 14

| | |
|---|---|
| L12 | 1.10 |
| L34 | 1.17 |
| Tg | 0.50 |
| Tr | 0.32 |
| f1 | −0.68 |
| f2 | −0.85 |
| d1 | 1.64 |
| d3 | 0.44 |

*Conditional expression

TABLE 15

| | | |
|---|---|---|
| Conditional Expression (1) | L12/L34 | 0.94 |
| Conditional Expression (2) | Tr/Tg | 0.65 |
| Conditional Expression (3) | f1/f2 | 0.80 |
| Conditional Expression (4) | d1/d3 | 3.72 |

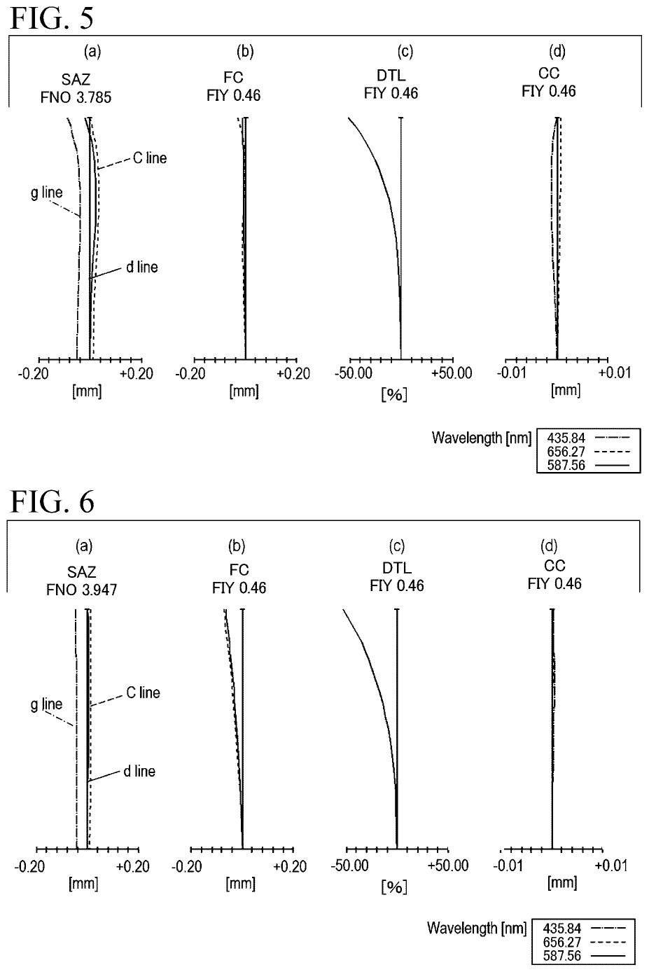

FIG. 5 is an aberration diagram of a laminated optical system of Example 3. FIG. 5A shows spherical aberration (SA). FIG. 5B shows astigmatism (AS). FIG. 5C shows distortion (DT). FIG. 5D shows chromatic aberration of magnification (CC).

### Example 4

### Surface Data

TABLE 16

| Surface | | | | |
|---|---|---|---|---|
| number (R) | r | d | nd | νd |
| 1 | ∞ | 0.20 | 1.52330 | 54.52 |
| 2 | ∞ | 0.07 | 1.52558 | 54.02 |
| 3* | 0.700 | 0.24 | | |
| 4 | ∞ | 0.21 | 1.52330 | 54.52 |
| 5 | ∞ | 0.07 | 1.52558 | 54.02 |
| 6* | 0.320 | 0.07 | | |
| 7* | 0.285 | 0.21 | 1.59950 | 29.43 |
| 8 | ∞ | 0.21 | 1.52330 | 54.52 |
| 9 (Stop) | ∞ | 0.10 | | |
| 10* | 0.430 | 0.15 | 1.52558 | 54.02 |
| 11 | ∞ | 0.30 | 1.52330 | 54.52 |
| 12 | ∞ | 0.63 | 1.47140 | 64.97 |
| 13 | ∞ | 0.00 | | |

*Aspheric data

TABLE 17
Third surface (R3)

| | | |
|---|---|---|
| k = −0.497 | | |
| A4 = −5.45224 × 10⁻¹ | A6 = 9.29775 × 10⁰ | A8 = −2.06352 × 10¹ |

Sixth surface (R6)

| | | |
|---|---|---|
| k = −3.456 | | |
| A4 = 1.52757 × 10¹ | A6 = −2.11811 × 10² | A8 = 1.33753 × 10³ |

Seventh surface (R7)

| | | |
|---|---|---|
| k = −3.850 | | |
| A4 = 1.94108 × 10¹ | A6 = −2.60002 × 10² | A8 = 1.13131 × 10³ |

Tenth surface (R10)

| | | |
|---|---|---|
| k = −2.499 | | |
| A4 = −2.78651 × 10⁰ | A6 = −2.73515 × 10¹ | A8 = 1.10215 × 10³ |

*Basic data

TABLE 18

| | |
|---|---|
| Focal distance | 0.491 |
| F number | 3.947 |
| Total length | 2.452 |
| Image height | 0.459 |
| Total angle of view (°) | 129.321 |
| DT_0.5d | −55.583 |
| fb (in air) | 0.91 |
| Total length (in air) | 2.43 |

*Element value

TABLE 19

| | |
|---|---|
| L12 | 0.79 |
| L34 | 0.97 |
| Tg | 0.20 |
| Tr | 0.31 |
| f1 | −1.33 |
| f2 | −0.61 |
| d1 | 1.27 |
| d3 | 0.42 |

*Conditional expression

TABLE 20

| | | |
|---|---|---|
| Conditional Expression (1) | L12/L34 | 0.81 |
| Conditional Expression (2) | Tr/Tg | 1.53 |
| Conditional Expression (3) | f1/f2 | 2.19 |
| Conditional Expression (4) | d1/d3 | 3.05 |

FIG. 6 is an aberration diagram of a laminated optical system of Example 4. FIG. 6A shows spherical aberration (SA). FIG. 6B shows astigmatism (AS). FIG. 6C shows distortion (DT). FIG. 6D shows chromatic aberration of magnification (CC).

As can be seen from the above examples, according to the laminated optical system of the present invention, it is possible to realize a total angle of view of 120° or more which is wider than that in the related art and good aberration characteristics, and it is possible to make compact and have improved environmental resistance to temperature changes. The laminated optical system of the present invention and the laminated optical system 500 of the above-described embodiment are applied to, for example, an imaging portion of an imaging system that is installed in a limited space and is expected to ensure a wider observation area or light receiving area and to exhibit resistance to external factors such as heat and are useful as a small optical system provided at the tip end of the insertion portion of the endoscope system as described above.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A laminated optical system comprising a first lens portion having a negative refractive power, a second lens portion having a negative refractive power, a third lens portion having a positive refractive power, and a fourth lens portion having a positive refractive power which are disposed in that order from an object side to an image side,
wherein the first lens portion has a first parallel flat plate and a first plano-concave lens having a first concave surface of which a concave surface faces the image side and a first flat surface on an outer peripheral side of the first concave surface which are disposed in that order from the object side to the image side,
wherein a flat surface on an image side of the first parallel flat plate and a flat surface on an object side of the first plano-concave lens are adhered to each other,
wherein the second lens portion has a second parallel flat plate and a second plano-concave lens having a second concave surface of which a concave surface faces the image side and a second flat surface on an outer peripheral side of the second concave surface which are disposed in that order from the object side to the image side,
wherein the first flat surface of the first plano-concave lens and a flat surface on the object side of the second parallel flat plate are adhered to each other, and a flat surface on the image side of the second parallel flat plate and the second flat surface of the second plano-concave lens are adhered to each other,
wherein the third lens portion has a first plano-convex lens having a first convex surface of which a convex surface faces the object side and a third flat surface on an outer peripheral side of the first convex surface and a third parallel flat plate which are disposed in that order from the object side to the image side,
wherein the second concave surface of the second plano-concave lens and the first convex surface of the first plano-convex lens are disposed with an interval therebetween,
wherein the second flat surface of the second plano-concave lens and the third flat surface of the first plano-convex lens are adhered to each other, and a flat surface on the image side of the first plano-convex lens and a flat surface on the object side of the third parallel flat plate are adhered to each other,
wherein the fourth lens portion has a second plano-convex lens having a second convex surface of which a convex surface faces the object side and a fourth flat surface on an outer peripheral side of the second convex surface and a fourth parallel flat plate which are disposed in that order from the object side to the image side,
wherein a flat surface on the image side of the third parallel flat plate and the second convex surface of the second plano-convex lens are disposed with an interval therebetween,
wherein the flat surface on the image side of the third parallel flat plate and the fourth flat surface of the second plano-convex lens are adhered to each other,
wherein a flat surface on the image side of the second plano-convex lens and a flat surface on the object side of the fourth parallel flat plate are adhered to each other,
wherein a linear expansion coefficient of the first plano-concave lens is greater than a linear expansion coefficient of the first parallel flat plate,
wherein a linear expansion coefficient of the second plano-concave lens is greater than a linear expansion coefficient of the second parallel flat plate,
wherein a linear expansion coefficient of the first plano-convex lens is greater than a linear expansion coefficient of the third parallel flat plate, and
wherein a linear expansion coefficient of the second plano-convex lens is greater than a linear expansion coefficient of the fourth parallel flat plate.

2. The laminated optical system according to claim 1,
wherein the first parallel flat plate, the second parallel flat plate, the third parallel flat plate, and the fourth parallel flat plate are made of glass,
wherein the first plano-concave lens, the second plano-concave lens, the first plano-convex lens, and the second plano-convex lens are made of a resin.

3. The laminated optical system according to claim 2,
wherein the first plano-concave lens, the second plano-concave lens, the first plano-convex lens, and the second plano-convex lens are made of an energy curable resin material.

4. The laminated optical system according to claim 1,
wherein, when a distance from a flat surface on the object side of the first parallel flat plate to the second concave surface of the second plano-concave lens on an optical axis is defined as L12 and a distance from the first convex surface of the first plano-convex lens to a flat surface on the image side of the fourth parallel flat plate on the optical axis is defined as L34, the following conditional expression is established.
$$0.8 < L 12 / L 34 < 1. \qquad ( 1 )$$

5. The laminated optical system according to claim 2,
wherein, when a distance from a flat surface on the object side of the first parallel flat plate to the second concave surface of the second plano-concave lens on an optical axis is defined as L12 and a distance from the first convex surface of the first plano-convex lens to a flat surface on the image side of the fourth parallel flat plate on the optical axis is defined as L34, the following conditional expression is established.
$$0.8 < L 12 / L 34 < 1. \qquad ( 1 )$$

6. The laminated optical system according to claim 3,
wherein, when a distance from a flat surface on the object side of the first parallel flat plate to the second concave surface of the second plano-concave lens on an optical axis is defined as L12 and a distance from the first convex surface of the first plano-convex lens to a flat surface on the image side of the fourth parallel flat plate on the optical axis is defined as L34, the following conditional expression is established.
$$0.8 < L 12 / L 34 < 1. \qquad ( 1 )$$

7. The laminated optical system according to claim 1,
wherein, when a thickness of the first parallel flat plate on an optical axis is defined as Tg and a thickness from the flat surface on the object side to the first flat surface on the image side of the first plano-concave lens is defined as Tr, the following conditional expression is established.
$$0.6 < Tr / Tg < 1.6 \qquad ( 2 )$$

8. The laminated optical system according to claim 2,
wherein, when a thickness of the first parallel flat plate on an optical axis is defined as Tg and a thickness from the flat surface on the object side to the first flat surface on the image side of the first plano-concave lens is defined as Tr, the following conditional expression is established.
$$0.6 < Tr / Tg < 1.6 \qquad ( 2 )$$

9. The laminated optical system according to claim 3,
wherein, when a thickness of the first parallel flat plate on an optical axis is defined as Tg and a thickness from the flat surface on the object side to the first flat surface on the image side of the first plano-concave lens is defined as Tr, the following conditional expression is established.
$$0.6 < Tr / Tg < 1.6 \qquad ( 2 )$$

10. The laminated optical system according to claim 1,
wherein, when the focal distance of the first lens portion is defined as f1 and the focal distance of the second lens portion is defined as f2, the following conditional expression is established.
$$0.7 < f 1 / f 2 < 3.5 \qquad ( 3 )$$

11. The laminated optical system according to claim 2,
wherein, when the focal distance of the first lens portion is defined as f1 and the focal distance of the second lens portion is defined as f2, the following conditional expression is established.
$$0.7 < f 1 / f 2 < 3.5 \qquad ( 3 )$$

12. The laminated optical system according to claim 3,
wherein, when the focal distance of the first lens portion is defined as f1 and the focal distance of the second lens portion is defined as f2, the following conditional expression is established.
$$0.7 < f 1 / f 2 < 3.5 \qquad ( 3 )$$

13. The laminated optical system according to claim 1, further comprising an aperture stop having an aperture disposed between the flat surface on the image side of the third parallel flat plate and the fourth flat surface of the second plano-convex lens,
wherein, when a distance from the flat surface on the object side of the first parallel flat plate to the aperture on an optical axis is defined as d1 and a distance from the first convex surface of the first plano-convex lens to the aperture on the optical axis is defined as d3, the following conditional expression is established.
$$3. < d 1 / d 3 < 3.8 \qquad ( 4 )$$

14. The laminated optical system according to claim 2, further comprising an aperture stop having an aperture disposed between the flat surface on the image side of the third parallel flat plate and the fourth flat surface of the second plano-convex lens,
wherein, when a distance from the flat surface on the object side of the first parallel flat plate to the aperture on an optical axis is defined as d1 and a distance from the first convex surface of the first plano-convex lens to the aperture on the optical axis is defined as d3, the following conditional expression is established.
$$3. < d 1 / d 3 < 3.8 \qquad ( 4 )$$

15. The laminated optical system according to claim 3, further comprising an aperture stop having an aperture disposed between the flat surface on the image side of the third parallel flat plate and the fourth flat surface of the second plano-convex lens,
wherein, when a distance from the flat surface on the object side of the first parallel flat plate to the aperture on an optical axis is defined as d1 and a distance from the first convex surface of the first plano-convex lens to the aperture on the optical axis is defined as d3, the following conditional expression is established.
$$3. < d 1 / d 3 < 3.8 \qquad ( 4 )$$

16. An endoscope comprising the laminated optical system according to claim 1.

17. An endoscope comprising the laminated optical system according to claim 2.

18. An endoscope comprising the laminated optical system according to claim 3.
